(19) United States
(12) Patent Application Publication
(10) Pub. No.: US 2002/0100760 A1
(43) Pub. Date: Aug. 1, 2002

(54) Condiment container

(76) Inventor: Thomas E. Rinks, Grand Rapids, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 09/771,827

(22) Filed: Jan. 29, 2001

(51) Int. Cl. C12C 1/027; A23B 4/00; A47G 19/00

(52) U.S. Cl. 220/574

(57) ABSTRACT

A condiment container intended primarily for distribution by the fast food industry to drive through customers. The condiment container includes an adhesive on its undersurface to permit temporary attachment of the container to various mounting surfaces, such as the dashboard, center console or arm rest of an automobile. The condiment container preferably includes a substantially rigid condiment container, such as the type commonly used by the fast food industry to supply barbecue and other sauces. The adhesive is preferably in the form of a double-sided tape. The first side of the tape preferably includes a substantially permanent adhesive that is secured to the undersurface of the container. The second side of the tape preferably includes a pressure sensitive adhesive that can temporarily secure the condiment container to the desired mounting surface. A release liner preferably covers the second side of the tape to protect it prior to use.

### BACKGROUND OF THE INVENTION

The present invention relates to condiment containers, and more particularly to a condiment container intended primarily for distribution by the fast food industry.

Fast food dining has become commonplace in today's society. A significant percentage of fast food is purchased at a drive through window for consumption in an automobile. Common fast food items, such as french fries, potato wedges, onion rings and chicken strips, are often consumed with condiments, such as ketchup, mustard and barbecue sauce. One particularly nagging problem arising with the consumption of fast food in an automobile is associated with the use of condiments. For example, fast food restaurants widely and almost exclusively use flexible condiment packets to provide their customers with ketchup. Conventional flexible condiment packets have proven to be inconvenient and messy, particularly in an automobile. To address these problems, a number of special use condiment containers have been developed.

An example of a special use container intended to address the problems of conventional condiment packets is shown in U.S. Pat. No. 5,540,333 to Gonzalez et al. The Gonzalez patent discloses a food container having an integrated condiment compartment. In the preferred embodiment, the Gonzalez patent discloses a paperboard french fry container having a smaller paperboard compartment mounted to the front of the french fry container. This product requires the consumer to empty conventional condiment packets into the compartment, potentially messing the container and leaving empty packets to be discarded. Further, to prevent spills, the consumer must maintain the french fry container in a substantially upright position, which can be rather difficult in a moving vehicle.

Another example is shown in U.S. Pat. No. 5,722,558 to Thompson. The Thompson patent discloses a drink lid having a compartment for holding a condiment, such as ketchup. This product suffers from some of the same problems associated with the invention of the Gonzalez patent. First, the consumer is required to empty conventional condiment packets into the compartment, potentially making a mess out of the lid and leaving messy packets to be discarded. Second, the consumer is required to maintain the drink in an upright position or risk spilling the contents of the compartment. Further, this product is only available to consumers that purchase a drink, and then only to those that will drink through a straw so that the drink can remain in a substantially upright position.

A further example is shown in U.S. Pat. No. 6,076,700 to Manges. The Manges patent discloses a condiment container having a mechanical clip that permits it to be secured to certain structures, such as the wall of a french fry container. The clip can be integrated into the container or can be configured to clip to the container when needed. Unfortunately, there are only a limited number of structures in an automobile to which the clip can be secured, and these structures are not allows in a location convenient to the consumer. Further, the clip can mark or damage some article and, as with the above described products, the article to which the container is clipped must be maintained in an upright position.

As can be seen, the special use containers of the prior art provide some improvement over conventional condiment packets, but still suffer from a variety of significant problems.

### SUMMARY OF THE INVENTION

The aforementioned problems are overcome by the present invention which provides a condiment container having an adhesive secured to its undersurface to permit the container to be temporarily secured to virtually any substantially horizontal surface, such as a dashboard, an arm rest or a center console in an automobile. The container is preferably a conventional, substantially rigid plastic container having a peel-off cover, such as the conventional type often used to hold barbecue sauce or other dipping sauces.

In a preferred embodiment, the container includes a conventional pressure sensitive adhesive (“PSA”) secured to its undersurface. The PSA is preferably covered by a conventional release liner that protects the adhesive prior to use. The PSA is selected to provide firm attachment to a conventional dashboard without leaving residue upon removal.

In a more preferred embodiment, the container includes conventional double-sided tape, with the first side of the tape secured to the undersurface of the container and the other side covered by a conventional release liner. If desired, the tape can include a foam carrier or backing.

In an even more preferred embodiment, opposite sides of the tape include different adhesives. The first side of the tape is preferably coated with a substantially permanent adhesive that makes it difficult to separate the tape from the container. The second side of the tape is preferably coated with a pressure sensitive adhesive that provides firm attachment to a conventional dashboard, yet can be peeled away from the dashboard without undue effort and without leaving residue.

The present invention provides a simple and effective condiment container that can be readily secured to and removed from a wide variety of substantially horizontal surface. The container is particularly well suited for use in an automobile where it can be temporarily secured to such elements as the dashboard, an armrest or the center console. The adhesive firmly secures the container so that it will not spill and, because it mounts to a wide variety of surfaces, can typically be located where the condiments are conveniently accessible to the consumer, even a driver. This provides potential safety benefits by permitting the container to be positioned to reduce the degree to which a driver must turn his or her eyes from the road to use the condiment. Further, the PSA permits the container to be easily removed without leaving any residue. When a foam carrier is used, the tape conforms more readily to textures and slight variations in the contour of the mounting surface to provide a stronger adhesive connection.

These and other objects, advantages, and features of the invention will be readily understood and appreciated by reference to the detailed description of the preferred embodiment and the drawings.

### BRIEF DESCRIPTION OF THE DRAWINGS

FIG. 1 is a bottom perspective view of a container according to a preferred embodiment of the present invention;

FIG. 2 is a bottom plan view of the present invention;

FIG. 3 is a right side elevational view of the present invention;

FIG. 4 is a sectional view of the present invention taken along line IV-IV of FIG. 2; and

FIG. 5 is a sectional view of an alternative embodiment of the present.

### DETAILED DESCRIPTION OF THE PREFERRED EMBODIMENT

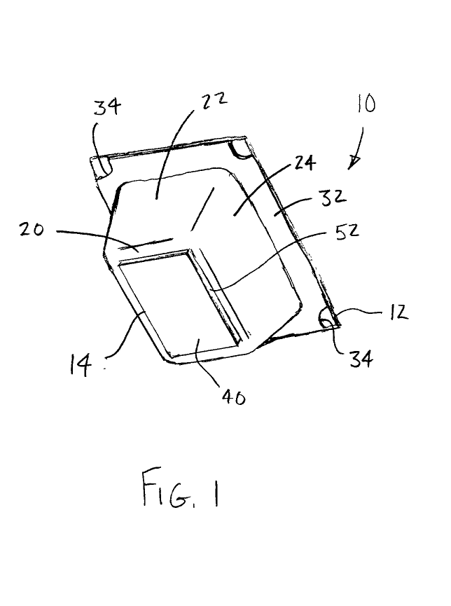

A condiment container manufactured in accordance with a preferred embodiment of the present invention is shown in FIG. 1, and generally designated 10. The condiment container 10 is intended primarily for distribution by the fast food industry to drive through customers. In this context, the container 10 can be temporarily secured to a mounting surface within an automobile, such as a dashboard, center console or arm rest, to provide ready access to the contents while reducing the risk of spilling. The container 10 includes a conventional substantially rigid plastic container having a peel-off cover 12. A double-sided tape 14 is secured to the undersurface of the container. The double-sided tape 14 permits the container 10 to be selectively secured to nearly any substantially horizontal surface where it is readily accessible to the consumer.

As noted above, the container 10 preferably includes a substantially rigid plastic container with a peel-off cover 12, for example, the type commonly used in the fast food industry to distribute barbecue and other sauces. Typically, these containers are manufactured from a polystyrene or other similar plastic. The container 10 includes a bottom wall 20 and four side walls 22, 24, 26 and 28 that cooperatively define a condiment reservoir 30. The container 10 further includes a rim 32 extending outwardly from the upper edges of the side walls 22, 24, 26 and 28. The rim 32 strengthens the container 10 and provides a surface against which to seal the peel-off cover 12. One or more of the corners of the rim 32 may define cutouts 34 that facilitate removal of the cover 12. The cover 12 is preferably a generally conventional cover, such as a laminated foil cover, that is secured to the upper surface of the rim 32 by a conventional adhesive. The illustrated container 10 is merely exemplary and the present invention is well suited for use with other types of containers.

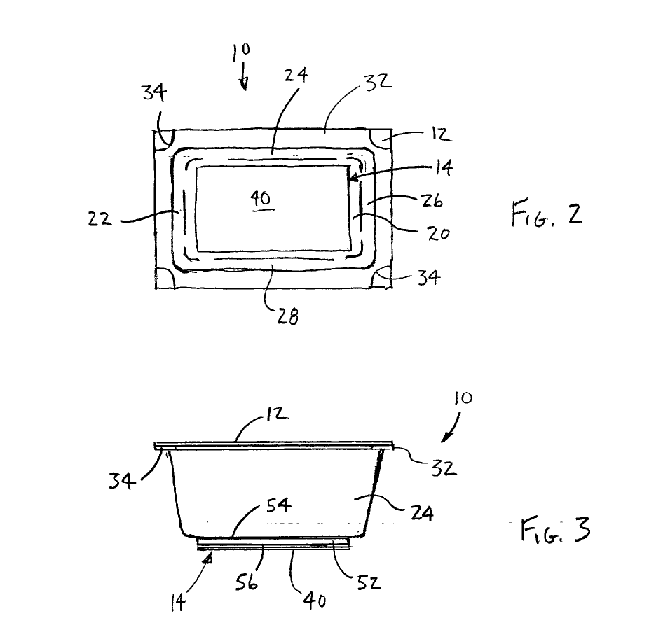

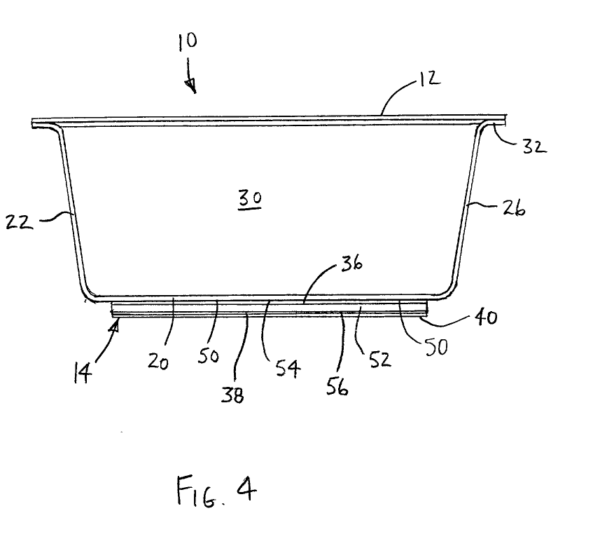

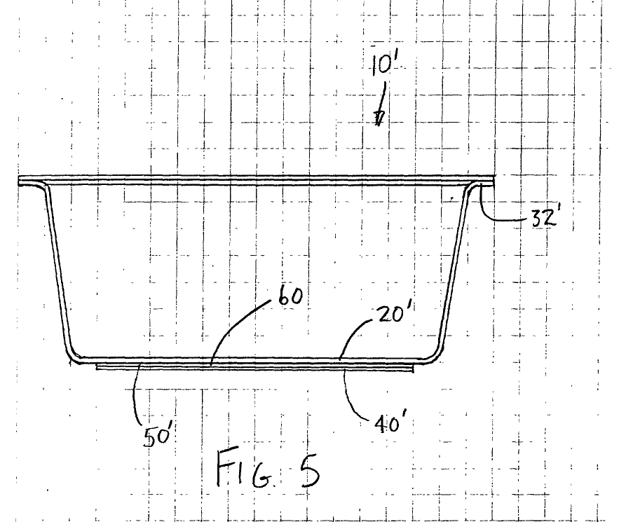

The container 10 further includes an adhesive material secured to or disposed upon the undersurface 50 of the bottom wall 20 (See FIGS. 2-4). The adhesive material is preferably in the form of a double-sided adhesive tape 14, and even more preferably a double-sided tape 14 with a foam carrier 52 (or backing) that permits the tape 14 to conform to textures and small variations in the contour of the mounting surface. The first side 36 of the adhesive tape 14 is secured directly to the undersurface 50 of the bottom wall 20. The first side 36 preferably includes a conventional pressure sensitive adhesive (“PSA”) 54, such as a rubber-based or acrylic-based adhesive, having a relatively high adhesive strength that makes it rather difficult to remove the double-sided tape 14 from the bottom wall 20. The second side 38 of the tape 14 includes a conventional PSA 56 having sufficient strength to retain the container 10 on conventional mounting surfaces, but preferably substantially less adhesive strength than the adhesive 54 of the first side 36. This reduces the likelihood that the tape 14 will separate from the container 10 when the container 10 is removed from a mounting surface. A wide variety of conventional adhesives will suffice for this application. If desired, the same adhesive can be applied to opposite sides of the tape 14, although this may lead to undesired separation of the tape 14 from the container 10 when the container 10 is removed from the mounting surface. In applications where the surface energy of the container 10 is greater than the surface energy of the mounting surface (not shown), the tape 14 may still peel away from the mounting surface more readily than the container 10 even if the same PSA is applied to both sides of the tape 14. The foam carrier 52 is preferably conventional foam carrier material, such as urethane, vinyl, elastomeric, polyethylene, acrylic or neoprene foam. If desired, the foam carrier 52 can be replaced by a conventional non-foam carrier (not shown). The foam carrier 52 does, however, provide improved performance in most applications as it permits the tape to fill many gaps and more evenly distributes stress over the bonded area.

A conventional release liner 40 that can be removed by the end user preferably covers the adhesive 56 on the second side 38 of the tape 14. The release liner 40, in a conventional manner, protects the PSA on the second side 38 of the tape 14 and is removed prior to use. The release liner 40 is preferably a paper (e.g. Kraft paper) or plastic sheet coated with a conventional release agent, such as silicone, PTFE varnish or other similar materials. The release liner 40 may include a tab (not shown) or may define a cut (lateral or longitudinal) to facilitate its removal.

As an alternative to double-sided tape 14, the container 10′ can include a layer of adhesive 60 (See FIG. 5) applied directly to the undersurface 50′ of the bottom wall 20′. The adhesive 60 is preferably a conventional PSA. As with the double-sided tape embodiment described above, the PSA 60 of this embodiment is selected to provide a firm, but peelably releasable attachment to conventional surfaces in an automobile, such as vinyl and plastic dashboard components. The adhesive 60 is preferably covered by a conventional release liner 40′.

In both embodiments, the tape 14 or adhesive 60 is preferably disposed on the undersurface of the container 10. This facilitates attachment of the container 10 to substantially horizontal surfaces and permits gravity to work in concert with the adhesive attachment, rather than against it. The tape 14 or adhesive 60 can, however, be alternatively disposed on a side surface of the container (not shown). This would permit attachment of the container to substantially vertical surfaces, but increases the load borne by the adhesive attachment and consequently the risk of unintended separation of the container 10 from its mounting surface. It may also require stronger adhesives and therefore may impact the ability to remove the container from the mounting surface without leaving residue or otherwise marking or damaging the surface in any way.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A condiment container assembly comprising:
a generally planar bottom wall, said bottom wall having upper and lower surfaces and including a peripheral edge;
a side wall extending upwardly from said peripheral edge of said bottom wall, said bottom wall and said side wall cooperating to define a reservoir for containing a quantity of a condiment; said side wall defining an opening for permitting access to said reservoir;
a cover removably secured over said opening to temporarily close said reservoir; and
an adhesive means disposed on said lower surface of said bottom wall for releasable securing said condiment container to a mounting surface.

2. The container of claim 1 wherein said adhesive means is a double-sided tape.

3. The container of claim 2 wherein said double-sided tape includes a first side secured to said bottom wall and a second side covered by a release liner.

4. The container of claim 3 wherein said second side is coated by a pressure sensitive adhesive.

5. The container of claim 4 wherein said double-sided tape includes a foam carrier.

6. The container of claim 5 wherein said first side is coated by a pressure sensitive adhesive.

7. The container of claim 1 wherein said adhesive means is a pressure sensitive adhesive applied to said bottom wall.

8. An assembly comprising:
a container defining a reservoir;
a cover closing said reservoir, said cover being removably to provide selective access to said reservoir; and
an adhesive means disposed on said container for releasable securing said condiment container to a mounting surface.

9. The assembly of claim 8 wherein said adhesive means includes a pressure sensitive adhesive; and
further comprising a release liner removably covering said pressure sensitive adhesive.

10. The assembly of claim 9 wherein said adhesive means includes a double-sided tape having a first side secured to said container and a second side covered by said release liner.

11. The assembly of claim 10 wherein said second side is coated by said pressure sensitive adhesive.

12. The assembly of claim 11 wherein said double-sided tape includes a foam carrier.

13. The assembly of claim 12 wherein said first side is coated by a pressure sensitive adhesive.

14. A condiment container assembly comprising:
a container having a generally planar bottom wall and a side wall, said bottom wall having a periphery, said side wall extending upwardly from said periphery of said bottom wall, said bottom wall and said side wall cooperating to define a reservoir having an opening;
a condiment disposed with said reservoir;
a cover secured over said opening to temporarily close said reservoir, said cover being removable to provide access to said condiment through said opening;
an adhesive means disposed on said container for releasable securing said condiment container to a mounting surface; and
a release liner covering said adhesive means.

15. The assembly of claim 14 wherein said adhesive means includes a pressure sensitive adhesive.

16. The assembly of claim 15 wherein said adhesive means includes a double-sided tape having a first side secured to said container and a second side covered by said release liner.

17. The assembly of claim 16 wherein said second side is coated by said pressure sensitive adhesive.

18. The assembly of claim 17 wherein said double-sided tape includes a foam carrier.

19. The assembly of claim 18 wherein said first side is coated by a pressure sensitive adhesive.

20. The assembly of claim 19 wherein said pressure sensitive adhesive of said first side has a greater adhesive strength than said pressure sensitive adhesive of said second side.
